(19) United States
(12) Patent Application Publication
(10) Pub. No.: US 2012/0171483 A1
(43) Pub. Date: Jul. 5, 2012

(54) USE OF ADHESIVE TAPES FOR BONDING OPTICAL COMPONENTS

(75) Inventors: Daniel Klier, Reinbek (DE); Marc Husemann, Hamburg (DE)

(73) Assignee: TESA SE, Hamburg (DE)

(21) Appl. No.: 13/379,882

(22) PCT Filed: Jun. 18, 2010
(86) PCT No.: PCT/EP2010/058607

§ 371 Date: Mar. 12, 2012

(30) Foreign Application Priority Data
Jul. 1, 2009 (DE) 10 2009 031 421.0

(51) Int. Cl. C09J 7/02; B32B 17/06

(52) U.S. Cl. 428/355 AC; 156/106

(57) ABSTRACT

Optical components are bondable by means of an adhesive tape that has at least one layer of a pressure-sensitive adhesive compound on basis of a polyacrylate having a weight-averaged molecular weight Mw in the range of 200000=M_{w}=1000000 g/mol, which can be obtained by radical copolymerization of at least the following components: (a) 55 to 92% by weight of one or more acryl monomers of the general formula CH₂═CH—COOR₁, where R1 is a hydrocarbon group having 4 to 14 carbon atoms, (b) 5 to 30% by weight of one or more copolymerizable monomers, wherein the glass transition temperature T_{G,bH} of the homopolymer from the monomer of the component (b) is no less than 0° C., or wherein the glass transition temperature T_{G,bH} of the copolymer from the monomers of the component (b) is no less than 0 DEG C., (c) 3 to 15% by weight of one or more copolymerizable monomers promoting a cross-linking reaction of the polyacrylate, wherein the polyacrylate is cross-linked. The cross-linked polyacrylate has a loss factor ranging between 0.2 and 0.4, a shear strength characterized by a maximum deflection xₘₐₓ in the microshear travel test of 200 to 600 μm, and an elastic portion in the polyacrylate of at least 60%.

This is a 371 of PCT/EP2010/058607, filed 18 Jun. 2010 (international filing date), and claims the priority of German Application No. 10 2009 031 421.0, filed 1 Jul. 2009.

Particularly in the field of electronic consumer devices, but also in the industrial and other areas, electronic data displays occupy a large domain. To protect the display modules from any damage due to external mechanical events such as impacts, for example, and also for light management, for thermal management, for provision of electrical functions, and other tasks, display systems of these kinds customarily have transparent protective windows covering the outside of the display modules.

Adhesive tapes used for bonding components or substrates that serve for optical purposes or are used for optical apparatus must frequently be light-reflecting, light-absorbing, highly transparent and/or light-resistant. Moreover, it may be important to exclude air. This has the advantage of reducing reflection produced by the transition from air to, for example, the optical medium of glass. In the case, for example, of the bonding of glasses or plastics windows for displays, panels or the like, even minute inclusions of air bubbles may adversely affect the viewing of the image.

For the bonding of optical components with pressure-sensitive adhesives (PSAs), the nature of the surfaces of substrate and adhesive is of critical significance. A particularly smooth PSA surface is needed for the bonding of optical components because perfect lamination of the optical substrates, which are likewise smooth, is necessary in order to obtain a defect-free optical component. To date, the surface nature of the release film used has always had a critical influence on the surface nature of the adhesive, since the adhesive has taken on the surface nature of the release film in the adhesive tape (the profile of the release film has impressed itself in the surface of the adhesive, causing this surface to take on the inverse profile of the release film surface). A good bonding strength often necessitates a high level of cohesion on the part of the PSA. Particularly in the case of very cohesive adhesives, however, even over a relatively long time, a persistent image of the release film surface remains after the release film has been removed. WO2008/149890 A refers to the great influence of the release film surface roughness on the resulting surface roughness of the PSA surface.

A high level of cohesion in the (pressure-sensitive) adhesives used is often necessary for the stability of the product construction, particularly at high temperatures. Although low levels of cohesion would promote flow of the (pressure-sensitive) adhesive following removal of a release film, and so lead to smoothing of the surface of the adhesive, the adhesive tapes obtained in such a way would in general no longer satisfy the requirements.

It is an object of the invention to provide a pressure-sensitive adhesive which can be used outstandingly for the bonding of optical components, which satisfies the exacting requirements in this area of application, and which at least largely overcomes the disadvantages of the prior art. The intention advantageously is to provide cohesive PSAs suitable for forming layers having very smooth surfaces.

The object is outstandingly achieved by means of an adhesive tape with at least one layer of a pressure-sensitive adhesive based on a polyacrylate having a weight-average molecular weight M_{w} in the range from 200000≦M_{w}≦1000000 g/mol, where the polyacrylate is the product of polymerization of at least the following components:
(a) 55% to 92% by weight of one or more acrylic monomers of the general formula

CH₂═CH—COOR₁
where R₁ represents a hydrocarbon radical having 4 to 14 carbon atoms, where particularly advantageously branched and/or nonbranched, saturated and/or unsaturated hydrocarbon radicals are used;
where additionally, if component (a) comprises only one monomer, the glass transition temperature T_{g,aH} of the homopolymer of the monomer of component (a) [defined as glass transition temperature value T_{g} according to DIN 53765:1994-03 (cf. section 2.2.1)] is not more than −20° C.
or, if component (a) comprises more than one monomer, the glass transition temperature T_{g,aC} of the copolymer of the monomers of component (a) according to the Fox equation is not more than −20° C., the glass transition temperature values T_{g} being used for calculation into the Fox equation being the T_{g} according to DIN 53765:1994-03 (cf. section 2.2.1) of the homopolymers of the individual monomers of component (a);
(b) 5% to 30% by weight of one or more copolymerizable monomers,
   where, if component (b) comprises only one monomer, the glass transition temperature T_{g,bH} of the homopolymer of the monomer of component (b) [defined as glass transition temperature value T_{g} according to DIN 53765:1994-03 (cf. section 2.2.1)] is not less than 0° C.
   or, if component (b) comprises more than one monomer, the glass transition temperature T_{g,bc} of the copolymer of the monomers of component (b) according to the Fox equation is not less than 0° C., the glass transition temperature values T_{g} being used for calculation into the Fox equation being the T_{g} according to DIN 53765:1994-03 (cf. section 2.2.1) of the homopolymers of the individual monomers of component (b);
(c) 3% to 15% by weight of one or more copolymerizable monomers promoting a crosslinking reaction of the polyacrylate,
wherein the polyacrylate is crosslinked,
and where the crosslinked polyacrylate is characterized by a loss factor (tan δ value) of between 0.2 and 0.4,
wherein the crosslinked polyacrylate has a shear strength characterized by a maximum deflection xₘₐₓ in the microshear travel test of 200 to 600 μm,
and where the crosslinked polyacrylate is characterized by an elastic component in the polyacrylate of at least 60%, determined in the microshear travel test.

It has surprisingly emerged that, with PSAs having suitable elasticity and viscosity behavior, as characterized more closely in the claims, it is possible to obtain very smooth layer surfaces.

Nevertheless, these adhesives continue to have a sufficiently high level of cohesion, which is necessary for adhesive bonds in the optical area, in order, for example, to ensure diecuttability or to prevent slipping of the optical components in vertical operation.

For more precise description and quantification of the degree of elastic and viscous component and also of the proportion of the components relative to one another, it is possible to employ the variables of storage modulus (G′), loss modulus (G″), and also the ratio G″/G′, referred to as the loss factor tan δ (tan delta), as may be determined by means of dynamic mechanical analysis (DMA). G′ is a measure of the elastic component, G″ a measure of the viscous component, of a substance. Both variables are dependent on the deformation frequency and the temperature.

The loss factor tan δ is a measure of the elasticity and the flow capacity of the substance under investigation.

The variables can be determined with the aid of a rheometer. In that case, the material under investigation is exposed to a sinusoidally oscillating shearing stress in a plate/plate arrangement, for example. In the case of instruments controlled by shear rate, the deformation is measured as a function of time, and the time offset of this deformation γ (gamma) is measured relative to the introduction of the shearing stress τ (tau). This time offset (phase shift between shear stress vector and deformation vector) is referred to as the phase angle δ (delta).

| | |
|---|---|
| Storage modulus G′ | G′ = τ/γ · cos(δ) |
| Loss modulus G″ | G″ = τ/γ · sin(δ) |
| Loss factor tan δ | tan δ = G′/G″ |

The figures for the aforementioned parameters within this specification relate to the measurement by means of a rheometer in plate-on-plate configuration, based on a round sample having a diameter of 8 mm and a thickness of 1 mm. Measurement conditions: temperature 25° C., otherwise standard conditions, frequency of the oscillating shearing load: 0.1 rad/s.

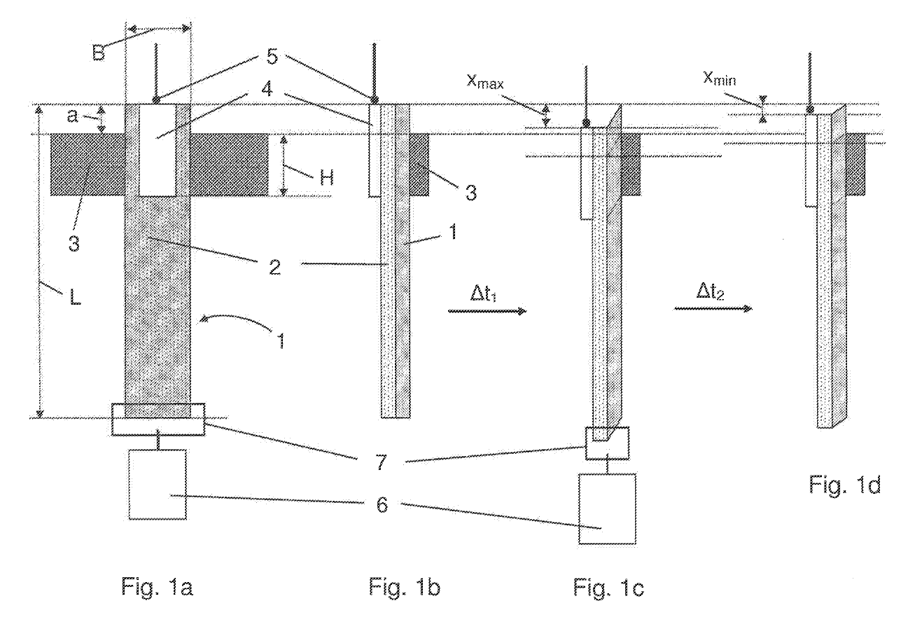

The figures for the maximum shear travel and for the elastic component relate to the results of the shear travel measurement. The maximum shear travel (i.e. the maximum deflection (xₘₐₓ) is a quantitative variable for describing the shear strength, while the elastic component is a quantitative measure for describing the resilience of the sample under investigation. The measurement principle is shown schematically in FIGS. 1a-1d (FIG. 1a: plan view of the measurement setup; and FIG. 1b: side elevation of the measurement setup).

A layer of the polyacrylate under investigation, 50 μm thick, is produced and crosslinked. The layer of polyacrylate adheres to a stabilizing film, such as a PET film. From this assembly a sample specimen [length (L) 50 mm, breadth (B) 10 mm] is cut.

The assembly formed from polyacrylate layer (1) and stabilizing film (2) is adhered by the polyacrylate layer side to a steel plate (3), cleaned with acetone beforehand, in such a way that the steel plate (3) protrudes beyond the adhesive tape to the right and left and that the adhesive tape (1) protrudes beyond the steel plate at the top edge by a distance (a) of 2 mm. The bond area of the polyacrylate layer (1) on the steel plate (3) is 13 mm×10 mm [height (H)×breadth (B)]. The bond site is subsequently rolled six times using a 2 kg steel roller, to give a firm adhesive bond.

The composite strip (1, 2) is provided with a stable reinforcing strip (4), attached flush to the top edge on the film side, and made of cardboard, for instance, and a travel gauge (deflection sensor) (5) is placed onto the strip (4). The sample is suspended vertically by means of the steel plate.

Measurement conditions selected are a temperature of 40° C. and otherwise standard conditions. The sample specimen under measurement is provided at the bottom end, by means of a bracket (7) (bracket weight 6.3 g), with a 500 g weight (6) (total load 506.3 g) and subjected to load for a time (Δt₁) of 15 minutes (see FIG. 1c). On account of the firm bonding of the polyacrylate layer (1) to the steel plate (3) and to the stabilizing film (2), shearing forces act on the polyacrylate layer. The shear path (maximum deflection of the travel gauge; shear path under load xₘₐₓ) of the polyacrylate layer after the mandated time at constant temperature is reported as the result ([xₘₐₓ]=μm).

After the end of the time under load (Δt₁), the weight (6) and the bracket (7) are removed, and the polyacrylate layer (1) performs a return movement as a result of relaxation (see FIG. 1d). After a load release time (Δt₂) again of 15 minutes, the shear path is measured again (residual deflection of the travel gauge; shear path under load relief xₘᵢₙ) of the polyacrylate layer ([xₘᵢₙ]=μm).

The elastic component Cₑₗₐₛₜ of the polyacrylate, in percent, is given by

$${C}_{elast} = \frac{( {x}_{max} - {x}_{min} ) * 100}{{x}_{max}}$$

The figures for the weight-average molecular weight M_{w} are based on the determination by gel permeation chromatography (GPC). The eluent used was THF containing 0.1% by volume trifluoroacetic acid. Measurement was made at 25° C. The preliminary column used was PSS-SDV, 5μ, 10³ Å, ID 8.0 mm×50 mm. Separation was carried out using the columns PSS-SDV, 5μ, 10³ and also 10⁵ and 10⁶ each with an ID of 8.0 mm×300 mm. The sample concentration was 4 g/l, the flow rate 1.0 ml per minute. Measurement took place against PMMA standards. (μ=μm 1 Å=10⁻¹⁰ m).

Where, within this specification, parameters are indicated in a range which is defined between two limits, the limiting values reported are considered to belong to the parameter range, unless anything is indicated to the contrary.

The invention additionally provides for the use of such an adhesive tape for bonding optical components, in other words a method for the adhesive bonding of optical components by means of an adhesive tape, where the adhesive tape has at least one layer of a pressure-sensitive adhesive based on a polyacrylate having a weight-average molecular weight M_{w} in the range from 200000≦M_{w}≦1000000 g/mol and being obtainable by free-radical copolymerization of at least the following components:
(a) 55% to 92% by weight of one or more acrylic monomers of the general formula

CH₂═CH—COOR₁
where R₁ represents a hydrocarbon radical having 4 to 14 carbon atoms, where particularly advantageously branched and/or nonbranched, saturated and/or unsaturated hydrocarbon radicals are used;
where additionally, if component (a) comprises only one monomer, the glass transition temperature T_{g,aH} of the homopolymer of the monomer of component (a) [defined as glass transition temperature value T_{g} according to DIN 53765:1994-03 (cf. section 2.2.1)] is not more than −20° C.
or, if component (a) comprises more than one monomer, the glass transition temperature T_{g,aC} of the copolymer of the monomers of component (a) according to the Fox equation is not more than −20° C., the glass transition temperature value T_{g} being used for calculation into the Fox equation being the T_{g} according to DIN 53765:1994-03 (cf. section 2.2.1) of the homopolymers of the individual monomers of component (a);
(b) 5% to 30% by weight of one or more copolymerizable monomers, where, if component (b) comprises only one monomer, the glass transition temperature T_{g,bH} of the homopolymer of the monomer of component (b) [defined as glass transition temperature value T_{g} according to DIN 53765:1994-03 (cf. section 2.2.1)] is not less than 0° C.
   or, if component (b) comprises more than one monomer, the glass transition temperature T_{g,bc} of the copolymer of the monomers of component (b) according to the Fox equation is not less than 0° C., the glass transition temperature value T_{g} being used for calculation into the Fox equation being the T_{g} according to DIN 53765:1994-03 (cf. section 2.2.1) of the homopolymers of the individual monomers of component (b);
(c) 3% to 15% by weight of one or more copolymerizable monomers promoting a crosslinking reaction of the polyacrylate,
wherein the polyacrylate is crosslinked,
and where the polyacrylate prior to the adhesive bonding of the optical components is characterized by a loss factor (tan δ value) of between 0.2 and 0.4,
wherein the polyacrylate has a shear strength characterized by a maximum deflection) xₘₐₓ in the microshear travel test of 200 to 600 μm,
   and where the crosslinked polyacrylate is characterized by an elastic component in the polyacrylate of at least 60%, determined in the microshear travel test.

The designation “for the adhesive bonding of optical components” refers in the sense of the present specification to any adhesive bond which serves for optical purposes, more particularly to those adhesive bonds which, on account of the light management associated with the bonded substrates, impose exacting requirements on the PSA.

Examples of end uses covered in particular by the use claimed are the use of the adhesives tapes of the invention for the lamination of polarizer films, retarder films, light enhancement films, light guide films, antireflection films, antiglare films, antisplinter films, on LCD modules, on the opposing side on one of the stated films or on transparent substrates with a structural function; and also the adhesive bonding of glasses, polymeric films, plastics windows, and the like in the production of optical data displays (LCDs; liquid crystal displays), OLED displays (organic light-emitting diode displays), other displays, touch panels, VDUs (monitor windows), and the like.

The aforementioned uses are also relevant in particular in the electronic devices segment, such as for TV sets, computer monitors, radar devices, oscilloscopes, portable computers (notebooks), PDAs (handhelds, organizers), cellphones, digital cameras, digital camcorders, navigation devices, horological items, fill level indicators on reservoir vessels, and the like.

The bonding of decorative elements is also covered by the intended use claimed, particularly when it involves demanding adhesive bonds.

Where adhesive tapes are employed for optical purposes, they may additionally advantageously ensure a filter effect, mechanical protection, suitability for thermal management (e.g., regulation of thermal radiation) and/or suitability for electrical management (provision of electrical or electronic functions), and also, possibly, the fulfillment of further functions.

The elastic component (microshear travel test) of the polyacrylate in the adhesive tape of the invention and the elastic component of the adhesive tape used in accordance with the invention are advantageously set such that they are located within the range between 70% and 95%.

The polyacrylate is polymerized more particularly by free radical polymerization of the comonomers used, in accordance with polymerization techniques that are known per se.

In order to determine the glass transition temperature of copolymers it is possible to employ the Fox equation (cf. T. G. Fox, Bull. Am. Phys. Soc. 1 (1956) p. 123), which states that the reciprocal glass transition temperature of the copolymer can be calculated from the weight fractions of the comonomers used and the glass transition temperatures of the corresponding homopolymers of the comonomers:

$$\frac{1}{{T}_{g}} = \frac{{w}_{1}}{{T}_{g , 1}} + \frac{{w}_{2}}{{T}_{g , 2}}$$

where w₁ and w₂ represent the mass fraction of the respective monomers 1 and 2 (% by weight) and T_{g,1} and T_{g,2} represent the glass transition temperatures of the homopolymers of each of the monomers 1 and 2, respectively, in K (kelvins).

In the case of more than two comonomers, the equation can be generalized to

$$\frac{1}{{T}_{g}} = {\sum }_{n} \frac{{w}_{n}}{{T}_{g , n}}$$

In the general equation, n represents the serial number of the monomers used, wₙ the mass fraction of the respective monomer n (% by weight), and T_{g,n} the respective glass transition temperature of the homopolymer of each of the monomers n, in K (kelvins).

The values for the glass transition temperatures of the corresponding homopolymers can also be found in relevant reference works.

The hydrocarbon radical of the acrylic monomers for component (a) may in particular be a branched or nonbranched alkyl or alkenyl group. Especially advantageous are hydrocarbon radicals having 4 to 10 carbon atoms.

Advantageous examples of acrylic monomers which can be used as component (a) are n-butyl acrylate, n-pentyl acrylate, n-hexyl acrylate, n-heptyl acrylate, n-octyl acrylate, n-nonyl acrylate, lauryl acrylate, stearyl acrylate, behenyl acrylate, and the corresponding branched isomers, such as isobutyl acrylate, 2-ethylhexyl acrylate, and isooctyl acrylate, for example.

For component (b), in a preferred procedure, use is made at least partly of one or more acrylic and/or methacrylic monomers of the general formula

CH₂═C(R₂)—COOR₃

where R₂ is H or R₂ is CH₃, where additionally R₃ represents a hydrocarbon radical, more particularly having 1 to 30 carbon atoms, and where the conditions in relation to the glass transition temperatures specified for component (b) are met.

The hydrocarbon radical of a respective acrylic monomer for component (b) may be branched or nonbranched, saturated or unsaturated, aliphatic or aromatic, substituted or unsubstituted.

Examples of advantageous monomers which can be used as component (b) include methyl acrylate, methyl methacrylate, ethyl acrylate, n-butyl methacrylate, n-octyl methacrylate, 2-ethylhexyl methacrylate, and isooctyl methacrylate.

Further advantageous monomers for component (b) are monofunctional acrylates and/or methacrylates of bridged cycloalkyl alcohols having at least six C atoms. The cycloalkyl alcohols may also be substituted, for example by C-1-6-alkyl groups, halogen atoms or cyano groups. Advantageous examples of monomers of these kinds are cyclohexyl methacrylate, isobornyl acrylate, isobornyl methacrylate, and 3,5-dimethyladamantyl acrylate.

As further advantageous monomers for component (b), either as sole monomers of component (b) or else, more particularly, in combination with the component (b) comonomers already described, it is possible to use nonacrylic monomers which possess a high static glass transition temperature (more particularly T_{g}≧0° C.). Suitable examples include aromatic vinyl compounds, such as styrene, for example, in which case the aromatic rings are composed preferably of C₄ to C₁₈ units and may also contain heteroatoms.

Particularly preferred examples are 4-vinylpyridine, N-vinylphthalimide, methylstyrene, 3,4-dimethoxystyrene, and 4-vinylbenzoic acid.

With advantage it is also possible to use acrylic monomers having aromatic radicals as component (b), such as, for example, benzyl acrylate, benzyl methacrylate, phenyl acrylate, phenyl methacrylate, tert-butylphenyl acrylate, tert-butylphenyl methacrylate, 4-biphenylyl acrylate and methacrylate, and 2-naphthyl acrylate and methacrylate.

For allowing and/or promoting crosslinking of the polyacrylate, in particular, the compounds of component (c) are added as comonomers. The polyacrylate may be crosslinked by thermal crosslinking and/or chemical crosslinking and/or by actinic radiation (more particularly UV radiation of electron beams). Setting the parameters referred to in the claims may be accomplished in particular by a deliberate crosslinking regime. Crosslinking in that case is carried out to a degree of crosslinking characterized by a loss factor (tan δ value) of between 0.2 and 0.4, a microshear travel of 200 to 600 μm, and an elastic component in the polyacrylate of at least 60%. Setting a degree of crosslinking of this type is part of the general art knowledge of the skilled person, more particularly of the skilled person within the field of adhesives and self-adhesives, and can be carried out by such a person readily, with use of his or her art knowledge.

As component (c) it is possible with advantage, exclusively or at least partly, in the second case especially advantageously in combination with copolymerizable photoinitiators, more particularly as denoted below, to use one or more acrylic and/or methyacrylic monomers of the general formula

CH₂═C(R₄)—COOR₅

where R₄ is H or R₄ is CH₃ and where R₅ is H or R₅ represents an alkyl group which has a functional group which is capable of or promotes a crosslinking reaction.

Functional groups in the above sense include, for example, carbonyl groups, acid groups, hydroxyl groups, epoxy groups, amine groups, and isocyanate groups.

In one preferred version of the invention the component (c) is used in an amount such that the amount of substance nₐ [in mol] of the monomers of component (a) is in a ratio to the amount of substance ti_{c} [in mol] of the functional groups of component (c) such that 1≦nₐ/n_{c}≦20, preferably 5≦nₐ/n_{c}≦16, more preferably 6≦nₐ/n_{c}≦11.

With particular advantage, but not necessarily, it is the case that, if component (c) comprises only one acrylic or methacrylic monomer, the glass transition temperature T_{g,cH} of the homopolymer of the acrylic or methacrylic monomer of component (c) [defined as glass transition temperature value T_{g} according to DIN 53765:1994-03 (cf. section 2.2.1)] is not less than 0° C., or, if component (c) comprises two or more acrylic and/or methacrylic monomers, the glass transition temperature T_{g,cC} of the copolymer of the acrylic and/or methacrylic monomers of component (c) according to the Fox equation is not less than 0° C., the glass transition temperature value T_{g} used for calculation into the Fox equation being the glass transition temperature value T_{g} according to DIN 53765:1994-03 (cf. section 2.2.1) of the homopolymers of the individual monomers of component (c).

Advantageous examples of corresponding functionalized (meth)acrylic monomers as component (c) are acrylic acid, methacrylic acid, hydroxyethyl acrylate, hydroxypropyl acrylate, hydroxyethyl methacrylate, hydroxypropyl methacrylate, allyl alcohol, maleic anhydride, itaconic anhydride, itaconic acid, glycidyl methacrylate, phenoxyethyl acrylate, phenoxyethyl methacrylate, 2-butoxyethyl methacrylate, 2-butoxyethyl acrylate, cyanoethyl methacrylate, cyanoethyl acrylate, glyceryl methacrylate, 6-hydroxyhexyl methacrylate, vinyl acetic acid, tetrahydrofurfuryl acrylate, β-acryloyloxypropionic acid, trichloroacrylic acid, fumaric acid, crotonic acid, and aconitic acid.

As component (c) it is possible advantageously exclusively or else in part, in the latter case in particular in combination of the aforementioned compounds as component (c), to use copolymerizable photoinitiators.

Suitable copolymerizable photoinitiators include Norrish I photoinitiators (photochemically fragmenting, more particular α-cleaving photoinitiators) and Norrish II photoinitiators (photochemically excited, hydrogen-abstracting photoinitiators). Advantageous examples of copolymerizable photoinitiators are, for example, benzoin acrylate and acrylated benzophenones, as for example the commercially available product Ebecryl P 36® from UCB. In principle it is possible to use all of the photoinitiators known to the skilled person which are copolymerizable (more particularly have polymerizable double bonds) and are able to crosslink the polymer via a free-radical mechanism under UV irradiation.

For the crosslinking reaction, crosslinkers and promoters may be admixed to the polyacrylate. More particularly, crosslinkers and/or promoters that are insensitive (not reactive) for the polymerization reaction may optionally be added even before or during the polymerization. Examples of suitable crosslinkers for electron beam crosslinking and UV crosslinking include difunctional or polyfunctional acrylates, difunctional or polyfunctional isocyanates (including those in blocked form) or difunctional or polyfunctional epoxides. Additionally it is also possible for thermally activatable crosslinkers to be added, such as Lewis acids, metal chelates or polyfunctional isocyanates, for example.

For optional crosslinking with UV light it is possible to admix the PSAs, rather than with the copolymerizable photoinitiators, or in addition to such photoinitiators, with noncopolymerizable UV-absorbing photoinitiators. Useful photoinitiators whose use is very effective are benzoin ethers, such as benzoin methylether and benzoin isopropyl ether, substituted acetophenones, such as 2,2-diethoxyacetophenone (available as Irgacure 651® from Ciba Geigy®), 2,2-dimethoxy-2-phenyl-1-phenylethanone, dimethoxyhydroxyacetophenone, substituted α-ketols, such as 2-methoxy-2-hydroxypropiophenone, aromatic sulfonyl chlorides, such as 2-naphthyl sulfonyl chloride, and photoactive oximes, such as 1-phenyl-1,2-propanedione-2-(O-ethoxycarbonyl)oxime, for example.

The abovementioned noncopolymerizable photoinitiators and/or others which can be used with advantage, especially those of the Norrish I or Norrish II type, may with particular advantage contain the following radicals: benzophenone-, acetophenone-, benzyl-, benzoin-, hydroxyalkylphenone-, phenyl cyclohexyl ketone-, anthraquinone-, trimethylbenzoylphosphine oxide-, methylthiophenyl morpholine ketone-, aminoketone-, azobenzoin-, thioxanthone-, hexarylbisimidazole-, triazine-, or fluorenone, it being possible for each of these radicals additionally to be substituted by one or more halogen atoms and/or one or more alkyloxy groups and/or one or more amino groups or hydroxyl groups. The naming of these radicals is done only by way of example for compounds which can be employed advantageously, and should not be understood as imposing any restriction.

The comonomer mixture to be polymerized, the polymer present in the polymerization, and/or the ready-polymerized polyacrylate may be admixed, advantageously prior to the crosslinking reaction, especially for supporting the setting of the desired product properties, with further components and/or additives, more particularly with additives of the kind that are not incorporated into the polymer and/or do not participate in the crosslinking reaction.

Additives which are advantageous for the polyacrylate of the adhesive tape particularly for use in the optical sphere include, for example, light stabilizers and ageing inhibitors.

It is possible to do without the presence of adhesive resins and plasticizers in the PSA which is used for the adhesive tape of the invention or for the adhesive tape used in accordance with the invention, and so one outstanding version of the adhesive tape of the invention and of the adhesive tape used in accordance with the invention in each case has a layer of pressure-sensitive adhesive, and more particularly is realized by a layer of pressure-sensitive adhesive (single-layer, carrierless adhesive tape) in which the PSA contains no added resins and/or plasticizers, and with particular advantage contains neither added resins nor added plasticizers. Such additions frequently possess adverse effects in the context of use for optical bonds. The resins used in accordance with the prior art as tackifier resins for acrylate PSAs are customarily polar resins, with the aim of achieving compatibility with the polyacrylate matrix. This generally results in the use of aromatic tackifier resins, which undergo yellowish discoloration on prolonged storage or on exposure to light.

For the production of a layer of pressure-sensitive adhesive, the polyacrylate obtainable as set out above and optionally additized is applied to one or both sides of a carrier, it being possible to use a permanent carrier which is retained in the adhesive tape construction in the application as well. With particular advantage, however, carrierless adhesive tapes, more particularly single-layer adhesive tapes, are produced, which in one very outstanding embodiment are composed, in the application, of the PSA layer alone (these being known as adhesive transfer tapes), and for prior handling, converting, and sale are provided on one or both sides with a temporary carrier and are more particularly wound into a roll.

For producing adhesive transfer tapes of this kind, the polyacrylate obtainable as set out above is advantageously coated onto a temporary carrier (more particularly, antiadhesive and/or antiadhesively furnished materials (known as liner materials, release materials or (release) liners)) such as siliconized papers, films or foils or the like, for example, in the desired layer thickness. In principle it is possible here to use all release materials that are suitable for polyacrylate PSAs.

It is also possible to produce adhesive tapes with two (pressure-sensitive) adhesive layers of different kinds, at least one of the layers being a PSA layer (of the invention) as described in this specification. The PSA layers may be directly adjacent (two-layer adhesive tape), and between the two PSA layers there may also optionally be one or more further layers, such as carrier layers or the like, for example (multilayer construction).

The polyacrylate is preferably crosslinked in the layer on the carrier material. The PSA is preferably formulated such that the pressure-sensitively adhesional properties are suitable for the use of the PSA for the described end use. Preferably in accordance with the invention, this takes place through choice of the appropriate degree of crosslinking of the polyacrylate. The polyacrylate in the present case is crosslinked to a degree of crosslinking which causes the realization of the parameters specified. By this means it is possible in particular to regulate the cohesion and the adhesion of the PSA, and also its flow behavior.

In one very preferred procedure, the crosslinking of the polyacrylate can be brought about thermally (that is, by supply of thermal energy), and in very preferred cases the crosslinking temperature is not more than 90° C., very preferably not more than 60° C., with the residence time being limited in particular to two minutes at most, very preferably to one minute at most, at this temperature. It is possible in this context, in particular, to combine crosslinking temperatures of 90° C. at most with crosslinking times of a minute at most, and, advantageously, to combine crosslinking temperatures of 60° C. at most with crosslinking times of two minutes at most.

For thermal crosslinking, the pressure-sensitive adhesive tapes of the invention are preferably passed through a drying tunnel. The drying tunnel performs two functions. On the one hand—where the acrylate PSA has been coated from solution—the solvents are removed. This is generally accomplished by gradual heating in order to avoid drying-bubbles. On the other hand—when a certain degree of drying has been attained—the heat is utilized to initiate the thermal crosslinking. The input of heat that is needed is dependent on the crosslinker system. Thus, for example, metal-chelate crosslinking can be carried out even at very low temperatures of 90° C., very preferably at 60° C., within short contact times, particularly in the drying tunnel (advantageously not more than two minutes, preferably not more than one minute).

Epoxy crosslinking, in contrast, requires longer crosslinking times and temperatures of 100° C. or more in order still to achieve efficient crosslinking in the drying tunnel. Furthermore, the input of heat is controlled by the drying tunnel length and by the belt speed.

It has emerged that adhesive tapes of the invention having outstanding suitability for use for optical bonds can be produced if aluminum chelate compounds are used, exclusively or partly, as crosslinkers. In contrast to other crosslinkers, these compounds show no tendency towards yellowing, and therefore result in very clear products. Polyacrylates crosslinked with aluminum chelates also show no tendency over time (as for example during prolonged storage) to undergo postcrosslinking or ageing, which means that the product properties are retained over a very long time period. For the crosslinking reaction with aluminum chelates, moreover, only very moderate temperatures are necessary for activation (see above), and so there is no risk of subsequent effects on adhesive tape components such as carriers, liners or the like (higher temperatures may lead, for example, to damage to carriers and/or liners, as for example to shrinkage, warping or the like). As a result, it is possible to produce homogeneous products of very high quality (especially with high optical quality).

In principle, adhesive tapes of the invention can also be attained by crosslinking by means of UV irradiation, and this crosslinking may be carried out alternatively or additionally to other crosslinking techniques.

UV crosslinking is carried out by means of shortwave ultraviolet irradiation in a wavelength range from 200 to 400 nm, depending on the UV photoinitiator used, more particularly using high-pressure or medium-pressure mercury lamps with an output of 80 to 400 W/cm. The irradiation intensity is matched to the respective quantum yield of the UV photoinitiator and to the degree of crosslinking that is to be set. The irradiation conditions (more particularly nature, intensity, dose, and duration of irradiation) are matched to the respective chemical composition of the polyacrylates to be crosslinked, more particularly such that the required parameter values of the crosslinked polyacrylate are achieved and the polyacrylate has the required suitability for the desired applications. The indications which follow are taken to be guideline values therefor, for parameter ranges in which regulation is advantageous.

Irradiation takes place advantageously with a UV-C dose of 50 to 200 mJ/cm², preferably from 75 to 150 mJ/cm². The dose has been measured using a UV dosimeter from the company Eltosch. The dose can be varied either by the output of the UV source or by the irradiation time, controlled in turn by the belt speed. For the purposes of the invention it is preferred to irradiate at low intensity (less than 200 mJ/cm² UV-C). By this means, “lacquering” of the PSA surface is avoided and the elasticity, which is needed for the inventive effect, is retained in the irradiated areas. Inadequate radiation doses, in contrast, lead to undercrosslinking of the PSA. The belt speed for UV crosslinking is preferably between 1 and 50 m/min, depending on the irradiation intensity of the UV source.

For setting the correct UV dose it may be appropriate to adapt the lamp output to the belt speed and/or to the nature of the pressure-sensitive adhesive tape.

In order to regulate the crosslinking reaction of the UV-crosslinked adhesive, it is preferred to limit the hard UV-C radiation in a wavelength range of less than 300 nm. The primary use of hard UV-C radiation results in a high crosslinking yield on the PSA surface. Lower-lying layers of PSA are crosslinked less strongly as a result of the short-wavelength irradiation. For the inventive method, therefore, the UV irradiation includes not only the UV-C radiation but also, very preferably, fractions of UV-A and UV-B radiation.

In addition, irradiation may be carried out in the absence of atmospheric oxygen. For this purpose, it is possible to cover the pressure-sensitive adhesive tape prior to UV irradiation, or the irradiation tunnel is flooded with an inert gas, such as nitrogen, for example.

Suitable UV radiation equipment is produced, for example, by the companies Eltosch, Fusion, and IST. Furthermore, doped glasses can be used in order to filter out particular radiation ranges.

Success has been achieved, particularly with the aforementioned techniques, and very especially here by means of thermal crosslinking, in producing very smooth adhesive tapes. Largely independently of the quality of substrate and release material surface, the adhesive tape of the invention and also the adhesive tape used in accordance with the invention permit simple and error-free processing without development of optical defects.

It has a good fluidity, and so is able to conform outstandingly to the surface of the substrates that are to be bonded. Nevertheless, the cohesion is high enough to ensure good bonding strength. The elastic component Cₑₗₐₛₜ of the polyacrylate is at least 60% (shear travel measurement).

Preferably, the surface of the adhesive layer of the adhesive tape of the invention and also of the adhesive tape used in accordance with the invention that is exposed on removal of an applied release material exhibits an average roughness R_{a,10 s}, within a time of 10 s after removal of the applied release material, which is less than or equal to 70%, preferably 60%, of the average roughness R_{a,0} of the surface of the release material applied to the layer of adhesive, the assumption being that the average roughness R_{a,o} of the adhesive layer exposed by removal of the release material at time zero (immediately after removal of the release material; “initial value”) and that of the surface of the release material which was on the layer of adhesive are the same.

Adhesive tapes of the invention and adhesives used in accordance with the invention are preferred particularly when the surface roughness of the exposed layer of PSA decreases, within a period of 24 hours after removal of the release film, to an average roughness value R_{a,24 h} of not more than 55%, preferably not more than 50%, more preferably not more than 45%, more preferably still not more than 40% of the initial value.

Preferred adhesives are able to accommodate both of the aforementioned states in the time sequence shown.

For storage or for sale, for example, adhesive tapes of the invention and adhesive tapes used in accordance with the invention are preferably lined on one or both sides with release materials whose average roughness Rₐ does not exceed a value of 350 nm, preferably 300 nm, more preferably 150 nm. By this means it is possible to ensure that the layers of adhesive on application possess a smoothness which is sufficient for optical applications. Using very smooth release materials, which can have an average roughness Rₐ of up to 1 nm or even less, allows the smoothness of the adhesive sheet to be optimized.

For optical applications, in particular, the PSA is formulated preferably such that in the form of a layer with a thickness of up to 250 μm, preferably up to 300 μm, it exhibits a transparency corresponding to a transmittance (emerging light intensity relative to irradiated light intensity in percent) of at least 95% (following subtraction beforehand of the reflection losses at the interface transitions from air to adhesive and from adhesive to air) or of at least 89% (emerging light intensity relative to light intensity irradiated absolutely, without removal of the components reflected at the interface transitions from air to adhesive and from adhesive to air from the irradiated light intensity; white light C according to CIE standard 13.3-1995). With further advantage the PSA exhibits a Haze value (ASTM D 1003) of not more than 5% or less.

The adhesive tape of the invention is especially suitable for permanent adhesive bonds, that is, in particular, bonds where the adhesive connection is to be maintained durably. The bonds may also be carried out over a large area, and can also be loaded with high weights. This represents an advantage in numerous applications, as for example with bonding of glass plates, since the articles or substrates bonded frequently have a high weight. Moreover, the adhesive tapes of the invention exhibit high robustness at elevated temperatures. The adhesive tapes of the invention are outstandingly used even for use in those applications where the bond area is not horizontally planar, but instead, for example, is of vertically planar orientation, as for example for the bonding of glasses and glass plates in LCD and plasma TVs. Here, in particular, a sufficiently high cohesion is necessary as well, since these devices are operated in vertical form and also may heat up to temperatures of 40° C. or more over a relatively long time period.

The crosslinked polyacrylate in the adhesive tapes of the invention and in the adhesive tapes used in accordance with the invention has an elasticity which is characterized by a loss factor (tan δ value) of between 0.2 and 0.4, and also a shear strength which is characterized by a maximum deflection xₘₐₓ in the microshear travel test of 200 to 600 μm, and also a resilience which is characterized by an elastic component in the polyacrylate of at least 60%, determined in the microshear travel test.

In accordance with the invention it is possible to supply PSAs and adhesive tapes produced therefrom that possess high cohesion and a high fluidity and that, surprisingly, are able to compensate the negative effect of the surface roughness produced by the application of a release material. The products therefore make it possible to achieve outstanding adhesive bonds in the optical area, and also very good laminations.

Experimental Section

Polyacrylate Polymerizations

### EXAMPLE 1

### Inventive

A 200 l reactor conventional for free-radical polymerizations was charged with 4900 g of acrylic acid, 51 kg of 2-ethylhexyl acrylate, 14 kg of methyl acrylate, and 53.3 kg of acetone/benzine/isopropanol (48.5:48.5:3). After nitrogen gas had been passed through the reactor for 45 minutes, it was heated to 58° C. with stirring, and 40 g of 2,2′-azoisobutyronitrile (AIBN) were added. The external heating bath was then heated to 75° C., and the reaction was carried out constantly at this external temperature. After a reaction time of 1 hour, a further 40 g of AIBN were added. After 5 hours and 10 hours, a dilution took place, each time using 15 kg of acetone/isopropanol (90:10). After 6 hours and 8 hours, 100 g portions of dicyclohexyl peroxydicarbonate (Perkadox 16®, Akzo Nobel) in solution, each in 800 g of acetone, were added. The reaction was terminated after a time of 24 hours, and the system was cooled to room temperature. GPC analysis showed an M_{w} of 507000 g/mol.

### EXAMPLE 2

### Inventive

A 200 l reactor conventional for free-radical polymerizations was charged with 4900 g of acrylic acid, 51 kg of 2-ethylhexyl acrylate, 14 kg of methyl acrylate, and 53.3 kg of acetone/benzine/isopropanol (48.5:48.5:2). After nitrogen gas had been passed through the reactor for 45 minutes, it was heated to 58° C. with stirring, and 40 g of 2,2′-azoisobutyronitrile (AIBN) were added. The external heating bath was then heated to 75° C., and the reaction was carried out constantly at this external temperature. After a reaction time of 1 hour, a further 40 g of AIBN were added. After 5 hours and 10 hours, a dilution took place, each time using 15 kg of acetone/isopropanol (90:10). After 6 hours and 8 hours, 100 g portions of dicyclohexyl peroxydicarbonate (Perkadox 16®, Akzo Nobel) in solution, each in 800 g of acetone, were added. The reaction was terminated after a time of 24 hours, and the system was cooled to room temperature. GPC analysis showed an M_{w} of 812000 g/mol.

### EXAMPLE 3

### Inventive

A procedure analogous to that of inventive example 2 was carried out.

### EXAMPLE 4

### Inventive

A procedure analogous to that of inventive example 2 was carried out.

### EXAMPLE 5

### Inventive

A procedure analogous to that of inventive example 2 was carried out.

### Example 6

### Inventive

A 200 l reactor conventional for free-radical polymerizations was charged with 2.4 kg of acrylic acid, 38.8 kg of 2-ethylhexyl acrylate, 38.8 kg of n-butyl acrylate, and 60 kg of acetone/isopropanol (99:4). After nitrogen gas had been passed through the reactor for 45 minutes, it was heated to 58° C. with stirring, and 20 g of 2,2′-azoisobutyronitrile (AIBN) were added. The external heating bath was then heated to 75° C., and the reaction was carried out constantly at this external temperature. After a reaction time of 1 hour, a further 20 g of AIBN were added. The reaction was terminated after a time of 72 hours by cooling to room temperature. According to the GPC test method, the molecular weight M_{w} was 780 000 g/mol.

### EXAMPLE 7

### Inventive

A 200 l reactor conventional for free-radical polymerizations was charged with 9.6 kg of acrylic acid, 45.4 kg of 2-ethylhexyl acrylate, 25.0 kg of n-butyl acrylate, and 60 kg of acetone/isopropanol (99:4). After nitrogen gas had been passed through the reactor for 45 minutes, it was heated to 58° C. with stirring, and 20 g of 2,2′-azoisobutyronitrile (AIBN) were added. The external heating bath was then heated to 75° C., and the reaction was carried out constantly at this external temperature. After a reaction time of 1 hour, a further 20 g of AIBN were added. The reaction was terminated after a time of 72 hours by cooling to room temperature. According to the GPC test method, the molecular weight M_{w} was 786 000 g/mol.

### REFERENCE EXAMPLE 1

A 200 l reactor conventional for free-radical polymerizations was charged with 3.2 kg of acrylic acid, 38.4 kg of 2-ethylhexyl acrylate, 38.4 kg of n-butyl acrylate, and 60 kg of acetone/isopropanol (99:1). After nitrogen gas had been passed through the reactor for 45 minutes, it was heated to 58° C. with stirring, and 20 g of 2,2′-azoisobutyronitrile (AIBN) were added. The external heating bath was then heated to 75° C., and the reaction was carried out constantly at this external temperature. After a reaction time of 1 hour, a further 20 g of AIBN were added. The reaction was terminated after a time of 72 hours by cooling to room temperature. According to the GPC test method, the molecular weight M_{w} was 1625000 g/mol.

### REFERENCE EXAMPLE 2

A 200 l reactor conventional for free-radical polymerizations was charged with 9.6 kg of acrylic acid, 35.2 kg of 2-ethylhexyl acrylate, 35.2 kg of n-butyl acrylate, and 60 kg of acetone/isopropanol (99:1). After nitrogen gas had been passed through the reactor for 45 minutes, it was heated to 58° C. with stirring, and 20 g of 2,2′-azoisobutyronitrile

(AIBN) were added. The external heating bath was then heated to 75° C., and the reaction was carried out constantly at this external temperature. After a reaction time of 1 hour, a further 20 g of AIBN were added. The reaction was terminated after a time of 72 hours by cooling to room temperature. According to the GPC test method, the molecular weight M_{w} was 1710000 g/mol.

### REFERENCE EXAMPLE 3

A 200 l reactor conventional for free-radical polymerizations was charged with 5.6 kg of acrylic acid, 16 kg of methyl acrylate, and 58.4 kg of 2-ethylhexyl acrylate, and 60 kg of acetone/isopropanol (90:10). After nitrogen gas had been passed through the reactor for 45 minutes, it was heated to 58° C. with stirring, and 40 g of 2,2′-azoisobutyronitrile (AIBN) were added. The external heating bath was then heated to 75° C., and the reaction was carried out constantly at this external temperature. After a reaction time of 1 hour, a further 40 g of AIBN were added. The reaction was terminated after a time of 12 hours by cooling to room temperature. According to the GPC test method, the molecular weight M_{w} was 188000 g/mol.

### REFERENCE EXAMPLE 4

A 200 l reactor conventional for free-radical polymerizations was charged with 5.6 kg of acrylic acid, 16 kg of methyl acrylate, and 58.4 kg of 2-ethylhexyl acrylate, and 60 kg of acetone/isopropanol (98:2). After nitrogen gas had been passed through the reactor for 45 minutes, it was heated to 58° C. with stirring, and 20 g of 2,2′-azoisobutyronitrile (AIBN) were added. The external heating bath was then heated to 75° C., and the reaction was carried out constantly at this external temperature. After a reaction time of 1 hour, a further 20 g of AIBN were added. The reaction was terminated after a time of 72 hours by cooling to room temperature. According to the GPC test method, the molecular weight M_{w} was 1580000 g/mol.

### REFERENCE EXAMPLE 5

A 200 l reactor conventional for free-radical polymerizations was charged with 2800 g of acrylic acid, 10.5 kg of cyclohexyl methacrylate, 56.7 kg of butyl acrylate, and 53.5 kg of acetone/benzine/isopropanol (48.5:48.5:2). After nitrogen gas had been passed through the reactor for 45 minutes, it was heated to 58° C. with stirring, and 40 g of 2,2′-azoisobutyronitrile (AIBN) were added. The external heating bath was then heated to 75° C., and the reaction was carried out constantly at this external temperature. After a reaction time of 1 hour, a further 40 g of AIBN were added. After 5 hours and 10 hours, a dilution took place, each time using 15 kg of acetone/isopropanol (90:10). After 6 hours and 8 hours, 100 g portions of dicyclohexyl peroxydicarbonate (Perkadox 16®, Akzo Nobel) in solution, each in 800 g of acetone, were added. The reaction was terminated after a time of 24 hours, and the system was cooled to room temperature. GPC analysis showed an M_{w} of 1230 000 g/mol.

### REFERENCE EXAMPLE 6

A 200 l reactor conventional for free-radical polymerizations was charged with 1400 g of acrylic acid, 58.8 kg of 2-ethylhexyl acrylate, 9.8 kg of isobornyl acrylate, and 53.5 kg of acetone/benzine/isopropanol (49.5:49.5:1). After nitrogen gas had been passed through the reactor for 45 minutes, it was heated to 58° C. with stirring, and 40 g of 2,2′-azoisobutyronitrile (AIBN) were added. The external heating bath was then heated to 75° C., and the reaction was carried out constantly at this external temperature. After a reaction time of 1 hour, a further 40 g of AIBN were added. After 5 hours and 10 hours, a dilution took place, each time using 15 kg of acetone/isopropanol (90:10). After 6 hours and 8 hours, 100 g portions of dicyclohexyl peroxydicarbonate (Perkadox 16®, Akzo Nobel) in solution, each in 800 g of acetone, were added. The reaction was terminated after a time of 24 hours, and the system was cooled to room temperature. GPC analysis showed an M_{w} of 1840 000 g/mol.

Production of the Adhesive Sheets for the Sample Specimens

Added to the polyacrylate-containing solution in each case were the below-indicated amounts (in parts by weight) of crosslinker (tris(2,4-pentanedionato)aluminum(III)=aluminum(III) acetylacetonate), based in each case on 100 parts by weight of polyacrylate (solids) (crosslinker used as a 3% solution in isopropanol). Dilution then took place with isopropanol to a solids content of 30%.

The polymer solutions obtained in this way were each coated out onto a siliconized polyester film 50 μm thick. Following removal of the solvent by evaporation at room temperature, drying took place in a drying oven, accompanied by crosslinking, under the following conditions:

Drying and Crosslinking Conditions:

| | Part by weight of | | |
|---|---|---|---|
| | crosslinker* | Temperature | Drying time |
| Example 1 | 0.3 | 120° C. | 15 min |
| Example 2 | 0.3 | 100° C. | 10 min |
| Example 3 | 0.3 | 90° C. | 2 min |
| Example 4 | 0.3 | 90° C. | 1 min |
| Example 5 | 0.3 | 60° C. | 2 min |
| Example 6 | 0.4 | 100° C. | 10 min |
| Example 7 | 0.5 | 100° C. | 10 min |
| Reference example 1 | 0.8 | 100° C. | 10 min |
| Reference example 2 | 0.8 | 100° C. | 10 min |
| Reference example 3 | 0.4 | 100° C. | 10 min |
| Reference example 4 | 0.6 | 100° C. | 10 min |
| Reference example 5 | 0.3 | 120° C. | 15 min |
| Reference example 6 | 0.3 | 120° C. | 15 min |

*based on 100 parts by weight of polyacrylate (solids)

The thickness of the layer of adhesive after drying was 50 μm in each case. A siliconized polyester film 50 μm thick was then laminated onto the free side of the polyacrylate layer.

Side B of the polyacrylate layer is that surface which lies on the first siliconized polyester film; side A of the polyacrylate layer is the surface onto which the second siliconized polyester film has been laminated.

For investigation of the examples according to the invention, samples with two different films for each of the adhesive tape sides were produced as set out above (for each example, one sample with the films A1 and B1, and one with the films A2 and B2):

Release films pointing to side A of the adhesive, Rₐ [nm]:

Release film A1: Rₐ=10.4 nm;

Release film A2: Rₐ=28.7 nm

Release films pointing to side B of the adhesive, Rₐ [nm]:

Release film B1: Rₐ=13.6 nm

Release film B2: Rₐ=31.3 nm

Analytical Methods

A. Shear Travel

A sample specimen [length 50 mm, breadth 10 mm] is cut from the adhesive sheet under investigation. One of the siliconized polyester films is removed from the sample specimen.

The sample specimen with the exposed polyacrylate layer side is adhered to a steel plate, cleaned with acetone beforehand, in such a way that the steel plate protrudes beyond the adhesive tape to the right and left, and that the adhesive tape protrudes beyond the steel plate at the top edge by a distance of 2 mm. The bond area of the polyacrylate layer on the steel plate is 13 mm×10 mm (height×breadth). The bond site is subsequently rolled over six times using a 2 kg steel roller, to give a firm adhesive bond.

The sample specimen is provided at the top edge on the film side, in a flush fashion, with a stable cardboard reinforcing strip, on which there is a travel gauge (deflection sensor). The sample is suspended vertically by means of the steel plate.

Measuring conditions selected are a temperature of 40° C. and otherwise standard conditions. The sample specimen under measurement is provided at the bottom end by means of a bracket (bracket weight 6.3 g) with a 500 g weight (total load 506.3 g) and subjected to load for a time Δt₁ of 15 minutes. On account of the firm bonding of the polyacrylate layer to the steel plate and to the stabilizing film, shearing forces act on the polyacrylate layer. The maximum deflection xₘₐₓ of the travel gauge after the mandated time at constant temperature is reported as the result, in μm.

After the expiry of the time Δt₁ under load, the weight and the bracket are removed, and the polyacrylate layer performs a return movement, as a result of relaxation. After a load release time Δt₂ again of 15 minutes, the residual deflection xₘᵢₙ of the travel gauge is measured.

The elastic component Cₑₗₐₛₜ of the polyacrylate, in percent, is given by

$${C}_{elast} = \frac{( {x}_{max} - {x}_{min} ) * 100}{{x}_{max}}$$

B. Rheometer Measurements

The measurements were carried out using an RDA II rheometer from Rheometrics Dynamic Systems in plate-on-plate configuration. Measurement took place on a round sample with a diameter of 8 mm and a thickness of 1 mm. The sample was obtained by laminating 20 layers of the adhesive sheets produced as above to one another, these sheets having for this purpose been freed from the respective carrier material, to give a carrierless adhesive sheet 1 mm thick, from which the round sample was able to be punched.

Measuring conditions: Temperature 25° C., otherwise standard conditions; frequency of the oscillating shearing stress: 0.1 rad/s.

C. Optical Assessment

The siliconized release film was removed from side A of the adhesive sheet under investigation. A polymethyl methacrylate film (PMMA film) 175 μm thick was laminated onto the exposed side of the adhesive sheet. The second siliconized release film was then removed from side B of the adhesive sheet, and a second PMMA film, 175 μm thick (Plexiglas Superclear®), was also laminated onto this side 0.25 square sample specimens (edge length 20 cm in each case) were cut from the resultant assembly of the polyacrylate layer and the PMMA films, and investigated visually (naked eye) for optical defects, both for the top face and for the bottom face. Every perceptible irregularity was recorded and counted. From the results for the 25 sample specimens, the average defect count (arithmetic mean of the errors counted on top face and bottom face together) was formed, and standardized to the number of defects per square meter (standardized average defect count n*). Defects are considered to be all irregularities, such as streaks, air inclusions, depressions, grooves and the like that are still perceptible to the human eye.

D. Molecular Weight Determinations

The weight-average molecular weight M_{w} was determined by means of gel permeation chromatography (GPC). The eluent used was THF containing 0.1% by volume trifluoroacetic acid. Measurement was made at 25° C. The preliminary column used was PSS-SDV, 5μ, 10³ Å, ID 8.0 mm×50 mm. Separation was carried out using the columns PSS-SDV, 5μ, 10³ and also 10⁵ and 10⁶ each with an ID of 8.0 mm×300 mm. The sample concentration was 4 g/l, the flow rate 1.0 ml per minute. Measurement took place against PMMA standards. (μ=μm; 1 Å=10⁻¹⁰ m).

E. Surface Roughness

The release material was removed from the adhesive sheet surface under investigation, and for long-term measurements, the sample was optionally stored flat and open for the stated time period such that the exposed side faced upward (clean-room environment under standard conditions).

In relation to the diagonal of an area of 320 μm×320 μm as a reference section, a confocal microscope (Nanofucs μscan) was used to determine the surface profile, from which the average roughness Rₐ was ascertained, for characterization of the surface roughness.

The average roughness Rₐ indicates the average distance of a measurement point on the surface to the center line. Within the reference section, the center line cuts the actual profile in such a way that the sum of the profile deviations, relative to the center line, becomes minimal, and it therefore corresponds to the arithmetic mean of all deviations from the center line.

The average roughness values Rₐ were determined after a time t of 10 seconds and also after a storage time t of 24 hours (times in each case after removal of the release material). The relative roughness R*_{a,t} after time t corresponds to the measured average roughness R_{a,t} after time t, relative to the average roughness R_{a,0} (time t=0) in the lined state, which corresponds to the roughness of the release film:

$${R}_{a , t}^{*} = \frac{{R}_{a , t}}{{R}_{a , 0}}$$

The change in average roughness over time, ΔRₐ, is defined as

$$Δ {R}_{a} = \frac{{R}_{a , 0} - {R}_{a , t}}{{R}_{a , 0}}$$

Results

The table below summarizes the results of the analytical measurement methods.

| | Analytical | | | | | | | |
|---|---|---|---|---|---|---|---|---|
| | technique | Example 1 | Example 2 | Example 3 | Example 4 | Example 5 | Example 6 | Example 7 |
| Molecular weight | D | 507000 | 812000 | 812000 | 812000 | 812000 | 780000 | 786000 |
| M_{w} [g/mol] | | | | | | | | |
| Maximum | A | 373 | 304 | 306 | 312 | 312 | 405 | 209 |
| deflection xₘₐₓ [μm] | | | | | | | | |
| Elastic component | A | 72 | 79 | 79 | 78 | 78 | 85 | 89 |
| Cₑₗₐₛₜ [%] | | | | | | | | |
| Standardized | C | 10 | 12 | 5 | 6 | 4 | 7 | 9 |
| average defect | | | | | | | | |
| count n* [m⁻²] | | | | | | | | |
| Rheology, tan δ | B | 0.378 | 0.322 | 0.330 | 0.336 | 0.336 | 0.224 | 0.320 |

| | Analytical | Reference | Reference | | Reference | Reference | Reference |
|---|---|---|---|---|---|---|---|
| | technique | example 1 | example 2 | Reference example 3 | example 4 | example 5 | example 6 |
| Molecular weight | D | 1625000 | 1710000 | 188000 | 1580000 | 1230000 | 1840000 |
| M_{w} [g/mol] | | | | | | | |
| Maximum | A | 157 | 141 | >1000 | 195 | 135 | 987 |
| deflection xₘₐₓ [μm] | | | | (*) | | | |
| Elastic component | A | 85 | 91 | — | 69 | 89 | 66 |
| Cₑₗₐₛₜ [%] | | | | | | | |
| Standardized | C | 43 | 39 | 52 | 24 | 25 | 39 |
| average defect | | | | | | | |
| count n* [m⁻²] | | | | | | | |
| Rheology, tan δ | B | 0.251 | 0.195 | 0.693 | 0.288 | 0.364 | 0.435 |

(*) In the event of a maximum deflection xₘₐₓ of more than 1000 μm (measurement limit), the measurement was discontinued; the polyacrylate composition does not exhibit sufficient shear strength

The adhesive tape of the invention has a low weight-average molecular weight, but nevertheless has a high cohesion. The reference examples generally have a very high molecular weight (>1000000 g/mol), and so the cohesion is relatively high. This results in sufficiently high shear strengths in the microshear test, but also in only a very high retention of surface roughness. As a result of the high molecular weight, the elastic component is likewise above 60%. An exception is reference example 3, since this example has only a very low molecular weight (<200 000 g/mol), and the level of cohesion, therefore, is very low. Here it was not possible to determine an elastic component, owing to the high fluidity.

Optical inspection of the PMMA-laminated sample specimens revealed a very low defect count for the adhesive tapes of the invention, in the region of 10 defects/m². Although this assessment is relatively coarse in quality terms, it is clearly apparent from the results of measurement that the defect counts for the reference specimens are significantly different, and in particular are at least twice as high. From the results it can also be taken that the aluminum chelate crosslinking can be carried out even at very low temperatures. There is virtually no change in the level of cohesion in the microshear test, and the elastic component as well remains relatively constant and above 60%. It can be seen, moreover, that as a result of a gentle thermal crosslinking the result can be improved still further. Examples 3, 4, and 5, in particular, show a very small number of defects/m² (<10 defects/m²).

The table below shows the measurement values for the investigations relating to the adhesive surface roughnesses as a function of time (analytical technique E) for the examples according to the invention.

Investigations Relating to the Adhesive Surface Roughnesses as a Function of Time (Analytical Technique E) for the Examples

| | Example 1 | | Example 2 | | Example 3 | | Example 4 | | Example 5 | | Example 6 | | Example 7 | |
|---|---|---|---|---|---|---|---|---|---|---|---|---|---|---|
| Release film | A1 | B1 | A1 | B1 | A1 | B1 | A1 | B1 | A1 | B1 | A1 | B1 | A1 | B1 |
| Release film surface | 10.4 | 13.6 | 10.4 | 13.6 | 10.4 | 13.6 | 10.4 | 13.6 | 10.4 | 13.6 | 10.4 | 13.6 | 10.4 | 13.6 |
| roughness Rₐ [nm] | | | | | | | | | | | | | | |
| R*_{a,10s} [%] | 57 | 48 | 59 | 53 | 58 | 50 | 58 | 50 | 58 | 50 | 59 | 58 | 53 | 58 |
| (= R*_{a,t} after 10 s) | | | | | | | | | | | | | | |
| R*_{a,24h} [%] | 43 | 41 | 50 | 49 | 48 | 41 | 46 | 39 | 48 | 40 | 51 | 51 | 45 | 47 |
| (= R*_{a,t} after 24 h) | | | | | | | | | | | | | | |
| Release film | A2 | B2 | A2 | B2 | A2 | B2 | A2 | B2 | A2 | B2 | A2 | B2 | A2 | B2 |
| Release film surface | 28.7 | 31.3 | 28.7 | 31.3 | 28.7 | 31.3 | 28.7 | 31.3 | 28.7 | 31.3 | 28.7 | 31.3 | 28.7 | 31.3 |
| roughness Rₐ [nm] | | | | | | | | | | | | | | |
| R*_{a,10s} [%] | 60 | 49 | 60 | 55 | 58 | 52 | 56 | 50 | 54 | 49 | 59 | 54 | 51 | 53 |
| (= R*_{a,t} after 10 s) | | | | | | | | | | | | | | |
| R*_{a,24h} [%] | 40 | 39 | 47 | 43 | 45 | 40 | 43 | 41 | 42 | 39 | 50 | 48 | 42 | 46 |
| (= R*_{a,t} after 24 h) | | | | | | | | | | | | | | |

Investigations Relating to the Adhesive Surface Roughnesses as a Function of Time (Analytical technique E) for the Reference Examples

| | Reference | | Reference | | Reference | | Reference | | Reference | | Reference | |
|---|---|---|---|---|---|---|---|---|---|---|---|---|
| | example 1 | | example 2 | | example 3 | | example 4 | | example 5 | | example 6 | |
| Release film | A1 | B1 | A1 | B1 | A1 | B1 | A1 | B1 | A1 | B1 | A1 | B1 |
| Release film surface | 10.4 | 13.6 | 10.4 | 13.6 | 10.4 | 13.6 | 10.4 | 13.6 | 10.4 | 13.6 | 10.4 | 13.6 |
| roughness Rₐ [nm] | | | | | | | | | | | | |
| R*_{a,10s} [%] | 77 | 75 | 80 | 78 | 60 | 62 | 71 | 73 | 65 | 62 | 71 | 69 |
| (= R*_{a,t} after 10 s) | | | | | | | | | | | | |
| R*_{a,24h} [%] | 54 | 56 | 68 | 64 | 41 | 43 | 58 | 62 | 49 | 50 | 56 | 52 |
| (= R*_{a,t} after 24 h) | | | | | | | | | | | | |
| Release film | A2 | B2 | A2 | B2 | A2 | B2 | A2 | B2 | A2 | B2 | A2 | B2 |
| Release film surface | 28.7 | 31.3 | 28.7 | 31.3 | 28.7 | 31.3 | 28.7 | 31.3 | 28.7 | 31.3 | 28.7 | 31.3 |
| roughness Rₐ [nm] | | | | | | | | | | | | |
| R*_{a,10s} [%] | 80 | 74 | 78 | 79 | 58 | 63 | 69 | 71 | 66 | 64 | 73 | 67 |
| (= R*_{a,t} after 10 s) | | | | | | | | | | | | |
| R*_{a,24h} [%] | 55 | 54 | 59 | 66 | 39 | 41 | 62 | 60 | 47 | 50 | 51 | 50 |
| (= R*_{a,t} after 24 h) | | | | | | | | | | | | |

From the table it can be seen that all of the examples according to the invention exhibit a significant reduction in surface roughness (average roughness Rₐ). Hence the value directly after removal of the release film (10-second values) is 60% or less. After waiting for 24 hours, the value in fact drops to 50% or less. The reference examples in the subsequent table, in contrast, all have significantly higher values after immediate removal of the release film or after 24 hours. Only reference example 3 attains the target values of the inventive examples. This can be explained by the low viscosity of this reference example. The above-described shear strength measurements, however, also demonstrated that for reference example 3 the measured cohesion was too low to carry out very good and stable optical adhesive bonds.

1. A method for the adhesive bonding of optical components by means of an adhesive tape, wherein
the adhesive tape has at least one layer of a pressure-sensitive adhesive based on a polyacrylate having a weight-average molecular weight M_{w} in the range from 200000≦M_{w}≦1000000 g/mol and being obtainable by free-radical copolymerization of at least the following components:
(a) 55% to 92% by weight of one or more acrylic monomers of the general formula
CH₂═CH—COOR₁
where R₁ represents a hydrocarbon radical having 4 to 14 carbon atoms, where a
glass transition temperature T_{g,aH} of the homopolymer of a monomer of component (a) [defined as glass transition temperature value T_{g} according to DIN 53765:1994-03] is not more than −20° C.
or a where the glass transition temperature T_{g,aC} of a copolymer of the monomers of component (a) according to the Fox equation is not more than −20° C.,
(b) 5% to 30% by weight of one or more copolymerizable monomers,
where a the glass transition temperature T_{g,bH} of a the homopolymer of the monomer of component (b) [defined as glass transition temperature value T_{g} according to DIN 53765:1994-03] is not less than 0° C.
or where a the glass transition temperature T_{g,bC} of a copolymer of the monomers of component (b) according to the Fox equation is not less than 0° C.,
(c) 3% to 15% by weight of one or more copolymerizable monomers promoting a crosslinking reaction of the polyacrylate,
wherein the polyacrylate is crosslinked,
where the crosslinked polyacrylate has a loss factor (tan δ value) of between 0.2 and 0.4,
wherein the crosslinked polyacrylate has a shear strength having characterized by a maximum deflection xₘₐₓ in the microshear travel test of 200 to 600 μm,
and where the crosslinked polyacrylate has an elastic component in the polyacrylate of at least 60%, determined in the microshear travel test.

2. The method of claim 1, wherein
component (b) comprises at least partly of one or more acrylic and/or methacrylic monomers of the general formula
CH₂═C(R₂)—COOR₃
where R₂ is H or R₂ is CH₃ and where R₃ represents a hydrocarbon radical having at least six carbon atoms, and for which the-conditions in relation to glass transition temperatures specified for component (b) are met.

3. The method of claim 1, wherein the adhesive tape is carrierless.

4. The method of claim 3, the adhesive tape is formed by the layer of pressure-sensitive adhesive.

5. The method of claim 1, wherein component (c) comprises at least partly of one or more acrylic and/or methacrylic monomers of the general formula
CH₂═C(R₄)—COOR₅
where R₄ is H or R₄ is CH₃ and where R₅ is H or R₅ represents an alkyl group which has a functional group capable of and/or promoting a crosslinking reaction of the polyacrylate.

6. The method of claim 5, wherein
the glass transition temperature T_{g,cH} of the homopolymer of the monomer of component (c) [defined as glass transition temperature value T_{g} according to DIN 53765:1994-03] is not less than 0° C.
or where the glass transition temperature T_{g,cC} of the copolymer of the monomers of component (c) according to the Fox equation is not less than 0° C.

7. The method of claim 1, further comprising
crosslinking the polyacrylate with at least one thermal initiation.

8. The method of claim 7, further comprising adding aluminum chelate as crosslinking initiator.

9. The method of claim 7, wherein a temperature at crosslinking does not exceed 90°.

10. The method of claim 1, wherein component (c) comprises at least partly of one or more copolymerizable photoinitiators.

11. An adhesive tape with at least one layer of a pressure-sensitive adhesive based on a polyacrylate having a weight-average molecular weight M_{w} in the range from 200000≦M_{w}≦1000000 g/mol, where the polyacrylate is the product of polymerization of at least the following components:
(a) 55% to 92% by weight of one or more acrylic monomers of the general formula
CH₂═CH—COOR₁
where R1 represents a hydrocarbon radical having 4 to 14 carbon atoms, where additionally, if component (a) comprises only one monomer, a glass transition temperature T_{g,aH} of a homopolymer of the monomer of component (a) [defined as glass transition temperature value T_{g} according to DIN 53765:1994-03 (cf. section 2.2.1)] is not more than −20° C.
or, if component (a) comprises more than one monomer, a the glass transition temperature T_{g,aC} of a the-copolymer of the monomers of component (a) according to the Fox equation is not more than −20° C., the glass transition temperature value T_{g} being used for calculation into the Fox equation being the T_{g} according to DIN 53765:1994-03 (cf. section 2.2.1) of the homopolymers of the individual monomers of component (a);
(b) 5% to 30% by weight of one or more copolymerizable monomers,
where, if component (b) comprises only one monomer, a glass transition temperature T_{g,aH} of a the-homopolymer of the monomer of component (b) [defined as glass transition temperature value T_{g} according to DIN 53765:1994-03 (cf. section 2.2.1)] is not less than 0° C.
or where a the glass transition temperature T_{g,bC} of a copolymer of the monomers of component (b) according to the Fox equation is not less than 0° C., a glass transition temperature value T_{g} being used for calculation into the Fox equation being the T_{g} according to DIN 53765:1994-03 (cf. section 2.2.1) of homopolymers of the individual monomers of component (b);
(c) 3% to 15% by weight of one or more copolymerizable monomers promoting a crosslinking reaction of the polyacrylate,
wherein the polyacrylate is crosslinked,
where the crosslinked polyacrylate has a loss factor (tan δ value) of between 0.2 and 0.4,
wherein the crosslinked polyacrylate has a shear strength having maximum deflection xₘₐₓ in the microshear travel test of 200 to 600 μm,
and where the crosslinked polyacrylate has an elastic component in the polyacrylate of at least 60%, determined in the microshear travel test.

12. The method of claim 7, wherein a temperature at crosslinking does not exceed 60° C.
